(19) United States
(12) Patent Application Publication
(10) Pub. No.: US 2025/0311712 A1
(43) Pub. Date: Oct. 9, 2025

(54) TRANSPORT LOCK FOR AN AGRICULTURAL APPLICATOR BOOM ASSEMBLY

(71) Applicant: CNH Industrial America LLC, New Holland, PA (US)

(72) Inventors: Roy A. Bittner, Reedsville, WI (US); Blaine Schwalbe, Valders, WI (US); Peter Hobson, Manitowoc, WI (US)

(21) Appl. No.: 18/630,069

(22) Filed: Apr. 9, 2024

(51) Int. Cl. A01M 7/00

(52) U.S. Cl. CPC A01M 7/0075; A01M 7/0078

(57) ABSTRACT

An agricultural applicator includes a chassis and a boom assembly supported by the chassis. The boom assembly includes a lift arm assembly and a boom arm supported by the lift arm assembly. The boom arm includes a first boom section pivotable between folded and extended positions about a first pivot joint defining a first axis of rotation and a second boom section coupled to the first and pivotable between folded and extend positions about a second pivot joint relative to the first. The second pivot joint defines a second axis of rotation different from the first. Furthermore, the boom arm includes nozzles positioned along the boom sections for applying agricultural product to the field. Moreover, the boom arm includes a transport lock to be received within a bounded opening for limiting pivoting of the second boom section to the extent of the opening when the first boom section is folded.

### FIELD

The present disclosure generally relates to agricultural applicators and, more particularly, to a transport lock for a boom assembly of the agricultural applicator.

### BACKGROUND

Various types of agricultural applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, agricultural product, fungicide, a pesticide, or another product).

The applicators may be self-propelled or pulled as an implement and may include a tank, a pump, a boom assembly, and a plurality of nozzles carried by the boom assembly at spaced locations. The boom assembly may include a pair of boom arms, with each boom arm extending to either side of the applicator when in an unfolded or extended state. Each boom arm may include multiple boom sections, each with a number of spray nozzles (also sometimes referred to as spray tips). During transport of the boom arms, one or more of the boom sections of the boom arms are moved to certain positions, such as folded and extended positions, to prevent the boom arms from becoming damaged or causing damage. However, movement of the applicator, such as driving over rough terrain, may prevent the boom section(s) from staying folded or extended.

Accordingly, a transport lock for an agricultural applicator boom assembly would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural applicator that includes a chassis and a boom assembly supported by the chassis. The boom assembly includes a lift arm assembly and a boom arm supported by the lift arm assembly. The boom arm includes a first boom section configured to pivot between a folded position and an extended position about a first pivot joint defining a first axis of rotation. Additionally, the boom arm includes a second boom section coupled to the first boom section and configured to pivot between a folded position and an extended position about a second pivot joint relative to the first boom section. The second pivot joint defines a second axis of rotation different from the first axis of rotation. Furthermore, the boom arm includes a plurality of nozzles positioned along the first boom section and the second boom section for selectively applying an agricultural product to a field surface. Moreover, the boom arm includes a transport lock configured to be received within a bounded opening for limiting pivoting of the second boom section about the second pivot joint to an extent of the bounded opening when the first boom section is in the folded position.

Additionally, in some aspects, the present subject matter is directed to a boom assembly for an agricultural applicator. The boom assembly includes a lift arm assembly and a boom arm supported by the lift arm assembly. The boom arm includes a primary boom section coupled to the lift arm assembly. Additionally, the boom arm includes an inner boom section pivotably coupled to the primary boom section and configured to pivot between a folded position and an extended position relative to the primary boom section. Furthermore, the boom arm includes a breakaway boom section pivotably coupled to the inner boom section and configured to pivot between a folded position and an extended position relative to the inner boom section. Moreover, the boom arm includes a plurality of nozzles positioned along the primary boom section, the inner boom section, and the breakaway boom section for selectively applying an agricultural product to a field surface. Additionally, the boom arm includes a bracket plate coupled to the primary boom section and protruding therefrom. The bracket plate is configured to engage the breakaway boom section to limit pivoting of the breakaway boom section when the inner boom section is in the folded position.

Furthermore, in some aspects, the present subject matter is directed to an agricultural system. The agricultural system includes a first boom section supported relative to a chassis of an agricultural applicator and configured to pivot between a folded position and an extended position about a first pivot joint. The first pivot joint defines a first axis of rotation. Additionally, the agricultural system includes a second boom section coupled to the first boom section and configured to pivot between a folded position and an extended position about a second pivot joint relative to the first boom section. The second pivot joint defines a second axis of rotation different from the first axis of rotation. Furthermore, the agricultural system includes a plurality of nozzles positioned along the first boom section and the second boom section for selectively applying an agricultural product to a field surface. Moreover, the agricultural system includes a transport lock configured to be received within a bounded opening for limiting pivoting of the second boom section about the second pivot join to an extended of the bounded opening when the first boom section is in the folded position.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural applicator in accordance with aspects of the present subject matter;

FIG. 2 illustrates a side view of the agricultural applicator shown in FIG. 1;

FIG. 3 illustrates a perspective view of a boom assembly of the agricultural applicator shown in FIGS. 1 and 2 with a boom arm in an extended position;

FIG. 4 illustrates a perspective view of the boom assembly of the agricultural applicator shown in FIGS. 1 and 2 with an inner boom section of the boom arm in a folded position;

FIG. 5 illustrates a perspective view of a transport lock for a boom assembly of an agricultural applicator in accordance with aspects of the present subject matter;

FIG. 6 illustrates a perspective view of the transport lock shown in FIG. 5 engaging a breakaway boom section of the applicator shown in FIGS. 1 and 2; and

FIG. 7 illustrates a cross-sectional view of the breakaway boom section of the applicator shown in FIGS. 1 and 2 about line 8-8.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations may be made in the present disclosure without departing from the scope or spirit of the disclosure. For instance, features illustrated or described as part may be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected” or “operably coupled” to each other to achieve the desired functionality, and any two components capable of being so associated may also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

In general, the present subject matter is directed to an agricultural applicator including a chassis and a boom assembly supported by the chassis. The boom assembly includes a lift arm assembly and one or more boom arms supported by the lift arm assembly. The boom arm includes a first boom section, such as an inner boom section, configured to pivot between a folded position and an extended position about a first pivot joint defining a first axis of rotation. Additionally, the boom arm includes a second boom section, such as a breakaway boom section, coupled to the first boom section and configured to pivot between a folded position and an extended position about a second pivot joint relative to the first boom section. The second pivot joint defines a second axis of rotation different from the first axis of rotation. For example, the second axis of rotation and the first axis of rotation may be oriented differently than each other. Furthermore, the boom arm includes a plurality of nozzles positioned along the first boom section and the second boom section for selectively applying an agricultural product, such as a pesticide, to a field surface.

Furthermore, a transport lock of the boom arm(s), such as a bracket plate, may be configured to be received within a bounded opening. For example, the transport lock may include a bracket portion for coupling the bracket plate to a component of the boom arm and a finger or extension portion protruding from the bracket portion to be received within the bounded opening. In this respect, the finger/extension portion may limit pivoting of the second or breakaway boom section about the second pivot joint to an extent of the bounded opening when the first or inner boom section is in the folded position.

Limiting or preventing unintended/undesired pivoting of the breakaway boom section toward a folded position while the agricultural applicator is transporting improves the operation of the agricultural applicator. More specifically, unintended/undesired pivoting of the breakaway boom section may occur while the applicator is traversing a field. For example, the field may include rough terrain that causes the breakaway section to pivot toward the folded position. Unintended pivoting of the breakaway section may cause the breakaway section to collide with objects which damage the breakaway section and/or the objects. As described above, the disclosed agricultural applicator includes a transport lock received within a bounded opening to limit pivoting of the breakaway boom section about the second pivot joint to an extent of the bounded opening when the inner boom section is in the folded position to prevent the breakaway section from colliding with objects due to unintended/undesired pivoting.

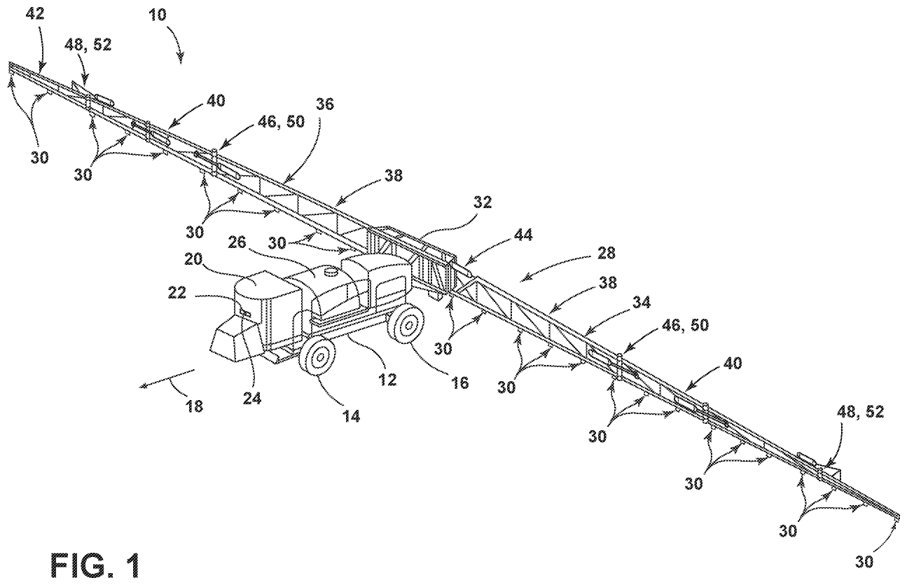

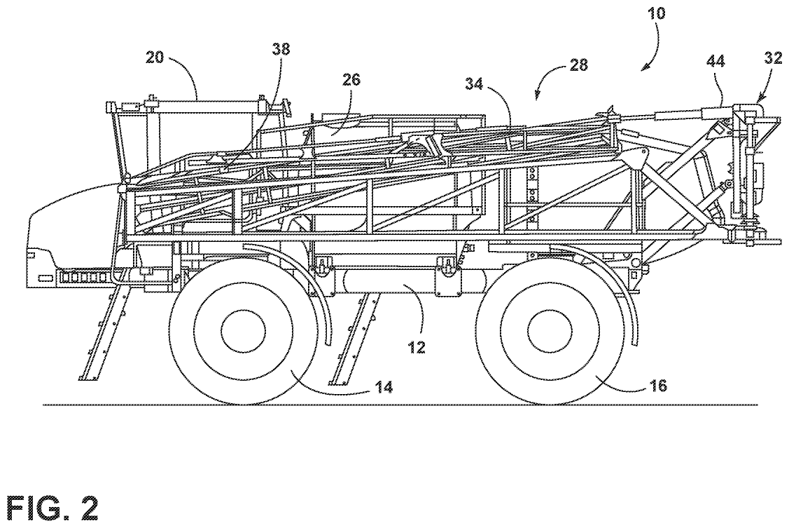

Referring now to FIGS. 1 and 2, an agricultural applicator 10 is generally illustrated as a self-propelled agricultural sprayer. However, in alternate embodiments, the applicator 10 may be configured as any other suitable type of applicator 10 configured to perform agricultural application operations, such as a tractor or other machine configured to haul or tow an application implement.

In various embodiments, the applicator 10 may include a chassis 12 configured to support or couple to a plurality of components. For example, front and rear wheels 14, 16 may be coupled to the chassis 12. The wheels 14, 16 may be configured to support the applicator 10 relative to a ground surface and move the applicator 10 in a forward direction of travel as indicated by arrow 18 in FIG. 1 (the direction of forward travel may be parallel to a fore-aft direction) across a field or the ground surface. In this regard, the applicator 10 may include a power plant, such as an engine, a motor, or a hybrid engine-motor combination, to move the applicator 10 along a field.

The chassis 12 may also support a cab 20, or any other form of operator's station, which provides various control or input devices 22 (e.g., levers, pedals, control panels, buttons, and/or the like) for providing various notifications to an operator and/or permitting the operator to control the operation of the applicator 10. For instance, as shown in FIG. 1, the applicator 10 may include a human-machine interface (HMI) 24 for displaying messages and/or alerts to the operator and/or for allowing the operator to interface with the applicator's controller or computing system through the one or more user input devices 22.

The chassis 12 may also support a tank 26 and a boom assembly 28 mounted to the chassis 12. The tank 26 is generally configured to store or hold an agricultural product, such as a pesticide, a fungicide, a rodenticide, a fertilizer, a nutrient, and/or the like. The agricultural product stored in the tank 26 may be selectively dispensed/supplied onto the underlying ground/field surface (e.g., plants and/or soil) through one or more nozzle assemblies 30 mounted on the boom assembly 28, such as on various boom sections of boom arms 34, 36 described below.

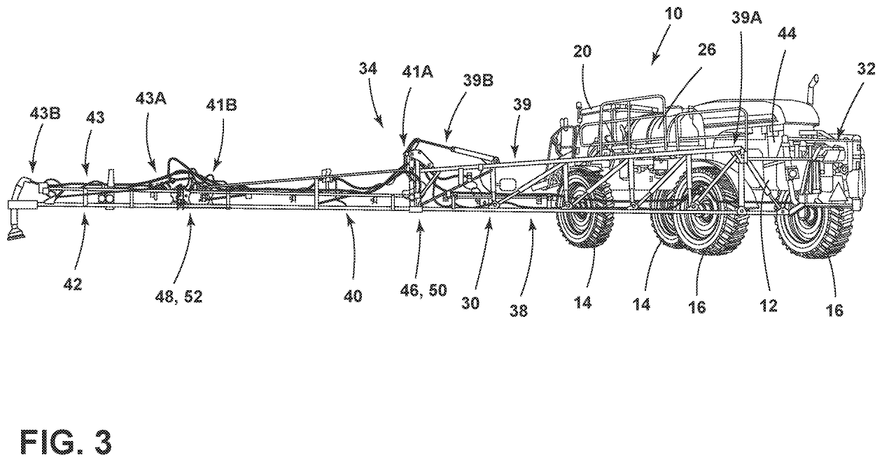

As shown in FIGS. 1 and 2, the boom assembly 28 may include a frame 32 that supports first and second boom arms 34, 36 in a cantilevered nature. The first and second boom arms 34, 36 are generally movable between an operative or unfolded/extended position (FIG. 1) and an inoperative or folded position (FIG. 2). When distributing the product, the first and/or second boom arm 34, 36 extends laterally outward from the applicator 10 to cover wide swaths of soil, as illustrated in FIG. 1. However, to facilitate transport, each boom arm 34, 36 of the boom assembly 28 may be independently folded fore or aft into the inoperative position, thereby reducing the overall width of the applicator 10. In this respect, as will be described below, each boom arm 34, 36 may include a plurality of boom sections pivotable relative to each other between unfolded/extended positions and inoperative/folded positions. As such, each boom arm 34, 36 may include or otherwise be associated with one or more actuators 60 (e.g., fluid-driven actuator(s)) (FIGS. 1, 3) for moving/pivoting the boom sections between the extended and folded positions. The actuator(s) 60 may be controlled by one or more computing systems of the applicator 10 automatically or when prompted by a user input from the input devices 22.

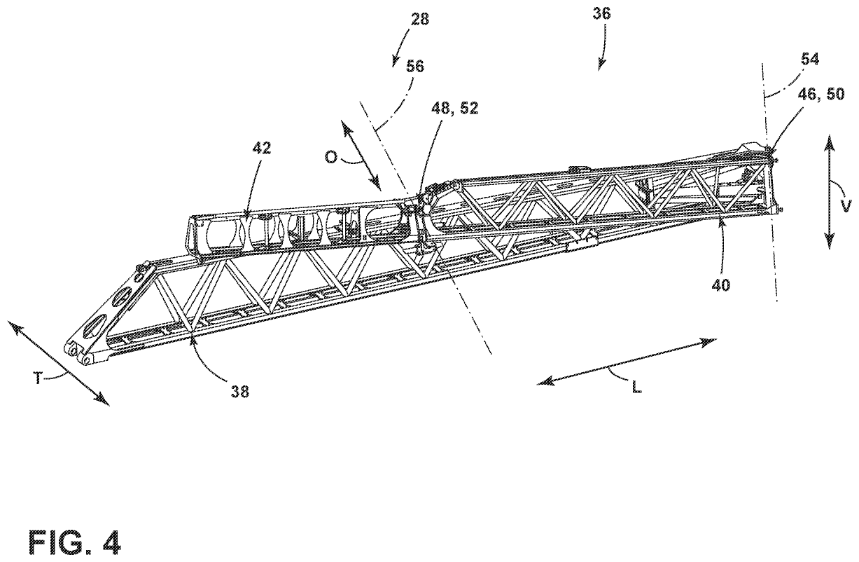

Referring now to FIGS. 3 and 4, differing views of the boom assembly 28 of the applicator 10 shown in FIGS. 1 and 2 are illustrated. Specifically, FIG. 3 illustrates a perspective view of the boom assembly 28 of the applicator 10 shown in FIGS. 1 and 2 with a boom arm in an extended position. Alternatively, FIG. 4 illustrates a perspective view of the boom assembly 28 of the applicator 10 shown in FIGS. 1 and 2 with an inner boom section of the boom arm in a folded position.

As shown in FIG. 3, each boom arm 34, 36 may include a plurality of boom sections. In the illustrated example, each boom arm 34, 36 includes a primary boom section 38, an inner boom section 40, and a breakaway boom section 42. In various examples, the primary boom section 38 may include a primary section frame 39, the inner boom section 40 may include an inner section frame 41, and/or the breakaway boom section 42 may include a breakaway section frame 43. Additionally, any boom section that is inboard of the breakaway boom section may be generically referred to as an inner boom section. Additionally, each primary boom section 38 may extend between an inner end 39A and an outer end 39B, each inner boom section 40 may extend between an inner end 41A and an outer end 41B, and each breakaway boom section 42 may extend between an inner end 43A and an outer end 43B.

The primary boom section 38 for each boom arm 34, 36 may be coupled to the frame 32 through a lift arm assembly 44 configured to raise and lower the boom arms 34, 36 relative to the ground or field surface. As shown in FIGS. 3 and 4, a first pivot joint 46, such as a hinge joint 50, may connect or couple the outer end 39B of each primary boom section 38 with the inner end 41A of the corresponding inner boom section 40. The hinge joint 50 may allow the inner boom section 40 to pivot or rotate relative to the primary boom section 38 between a folded position (FIG. 4), in which the inner boom section 40 and the primary boom section 38 are substantially parallel or otherwise not aligned, and an extended position (FIG. 3), in which the inner boom section 40 and the primary boom section 38 are aligned.

Likewise, a second pivot joint 48, such as a breakaway hinge joint 52, may connect or couple the outer end 41B of each inner boom section 40 with the inner end 43A of the corresponding breakaway boom section 42. The breakaway hinge joint 52 may allow the breakaway boom section 42 to pivot or rotate relative to the inner boom section 40 between a folded position (not shown) in which the breakaway boom section 42 and the inner boom section 40 are substantially parallel or otherwise not aligned and an extended position (FIGS. 3, 4) in which the breakaway boom section 42 and the inner boom section 40 are aligned.

Furthermore, as shown in FIG. 4, the hinge joint 50 may define a first axis of rotation 54 about which the inner boom section 40 pivots between the folded position and the extended position relative to the primary boom section 38. Likewise, the breakaway hinge joint 52 may define a second axis of rotation 56 about which the breakaway boom section 42 pivots between the folded position and the extended position relative to the inner boom section 40. The first axis of rotation 54 and the second axis of rotation 56 are oriented differently from each other. For example, as shown in FIG. 4, the first axis of rotation 54 may correspond to a vertical axis of rotation oriented in a vertical direction V relative to the ground or field surface. In this respect, the inner boom section 40 may pivot or rotate side-to-side, as opposed to upwardly and downwardly, relative to the ground or field surface. Furthermore, the second axis of rotation 56 may correspond to an oblique axis of rotation oriented in an oblique direction O relative to the ground or field surface in which the breakaway boom section 42 moves simultaneously upward in the vertical direction V while pivoting toward the extended position and downward in the vertical direction V while pivoting toward the folded position. However, it should be appreciated that the oblique direction axis of rotation may be oriented in any other direction that is not parallel to any of the vertical direction V, the transverse direction T, and longitudinal direction L relative to the ground or field surface.

Moreover, it should be appreciated that the first axis of rotation 54 may be oriented in any other suitable manner such that the inner boom section 40 pivots about the hinge joint 50 relative to the primary boom section 38 and such that the first axis of rotation 54 is oriented differently than the second axis of rotation 56 relative to the ground or field surface. For example, the first axis of rotation 54 may be oriented in an oblique direction relative to the ground or field surface in which the inner boom section 40 moves simultaneously upward in the vertical direction V and pivotably toward the folded position while the second axis of rotation 56 may be oriented in the lateral direction relative to the ground or field surface in which the breakaway boom section 42 may pivot or rotate upwardly and downwardly relative to the ground or field surface.

Likewise, it should be appreciated that the second axis of rotation 56 may be oriented in any other suitable manner such that the breakaway boom section 42 pivots about the breakaway hinge joint 52 relative to the inner boom section 40 and such that the second axis of rotation 56 is oriented differently than the first axis of rotation 54 relative to the ground or field surface. For example, the second axis of rotation 56 may be oriented in the lateral direction L relative to the ground or field surface in which the breakaway boom section 42 may pivot or rotate upwardly and downwardly relative to the ground or field surface while the first axis of rotation 54 may be oriented in an oblique direction relative to the ground or field surface in which the inner boom section 40 moves simultaneously upward in the vertical direction V and pivotably toward the folded position.

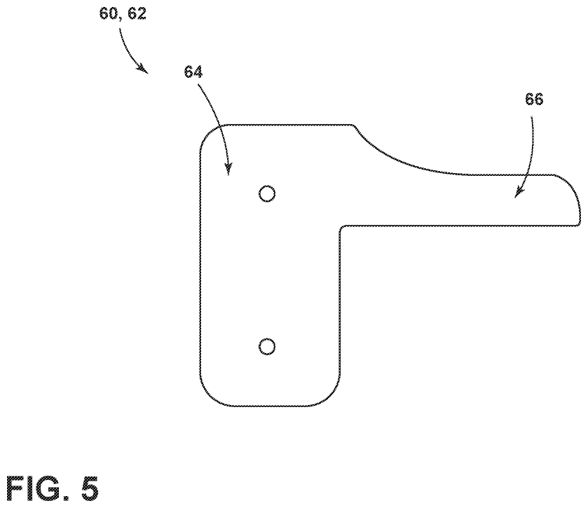

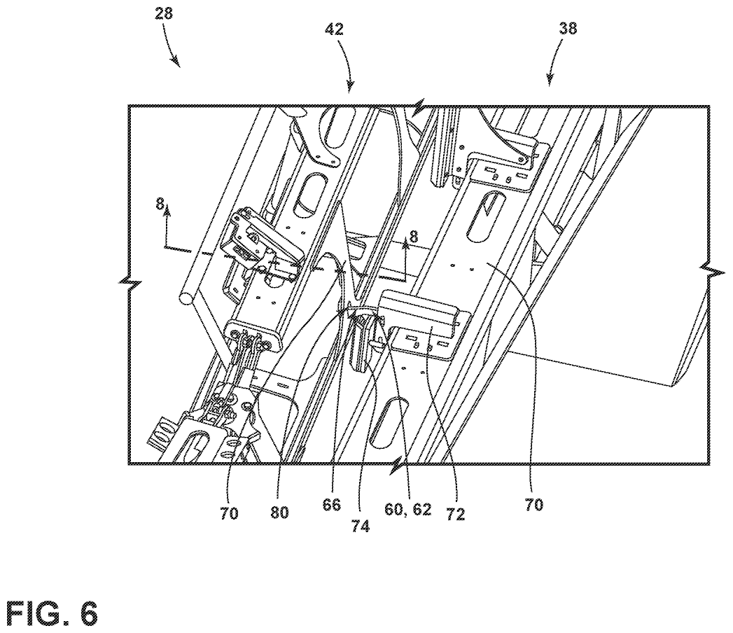

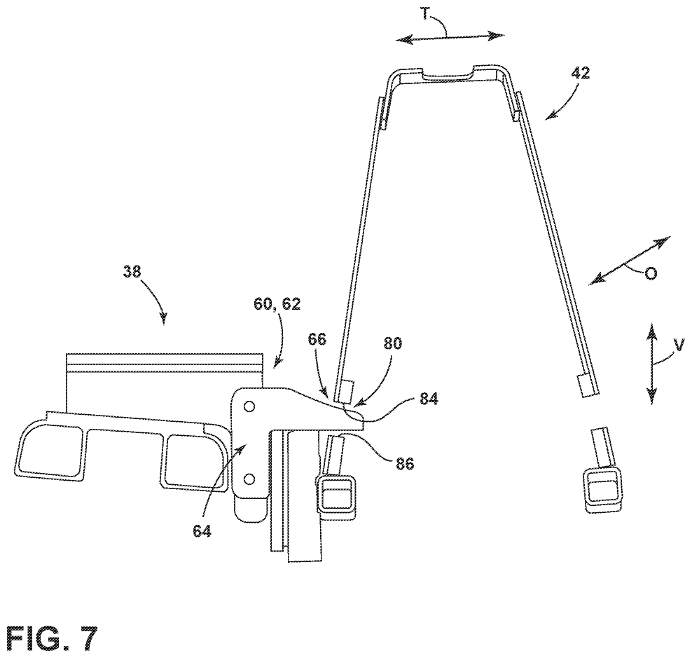

Referring now to FIGS. 5 through 7, differing views of an example embodiment of a transport lock 60 for a boom assembly of an agricultural applicator are illustrated. Specifically, FIG. 5 illustrates a perspective view of the transport lock 60. Additionally, FIG. 6 illustrates a perspective view of the transport lock 60 shown in FIG. 5 engaging the breakaway boom section 42 of the applicator 10 shown in FIGS. 1 and 2. Furthermore, FIG. 7 illustrates a cross-sectional view of the breakaway boom section 42 of the applicator 10 shown in FIGS. 1 and 2 about line 8-8 in FIG. 6, particularly illustrating the transport lock 60 shown in FIG. 5 engaging the breakaway boom section 42.

The boom assembly 28 of the applicator 10 may include the transport lock 60. As will be described below, the transport lock 60 is configured to limit pivoting of the breakaway boom section 42 about the breakaway hinge joint 52. As shown in FIGS. 5 through 7, the transport lock 60 is configured as a bracket plate 62. The bracket plate 62 may include a bracket portion 64 for fixedly coupling the bracket plate 62 (e.g., via weld(s), fastener(s), etc.) to a component of the boom assembly 28 of the applicator 10, such as to the primary boom section 38. For example, the bracket plate 62 may be fixedly coupled to a damper bracket 72, which is, in turn, fixedly coupled to a structural member 70 of the primary boom section 38 for supporting a damper 74 to prevent the breakaway section 42 from directly impacting the primary boom section 38 as the breakaway boom section 42 reaches the folded position. In this respect, the bracket plate 62 may be fixed relative to the primary boom section 38. However, it should be appreciated that the bracket plate 62 may be fixedly coupled to any other suitable component of the boom assembly 28 of the applicator 10. For example, in some embodiments, the bracket plate 62 may be fixedly coupled to a component of the breakaway boom section 42.

Additionally, the bracket plate 62 may include a finger or extension portion 66 protruding from the bracket portion 64. As shown in FIG. 6, the extension portion 66 protrudes laterally relative to the primary boom section 38 to which the bracket plate 62 is coupled. As will be described below, the extension portion 66 is configured to be received within an opening, such as a bounded opening, for limiting or preventing pivoting of the breakaway boom section 42 about the breakaway hinge joint 52 to an extent of the bounded opening when the inner boom section 40 is in the folded position.

As shown in FIGS. 6 and 7, the breakaway boom section 42 defines a lock opening 80 therethrough for receiving the extension portion 66 of the bracket plate 62 therethrough when the inner boom section 40 is pivoted to the folded position and while the breakaway boom section 42 is in the extended position. In this respect, the first axis of rotation 54, about which the inner boom section 40 pivots between the extended and folded positions, is oriented such that the lock opening 80 aligns with the extension portion 66 of the bracket plate 62 as the inner boom section 40 pivots to the folded position. As such, the lock opening 80 may receive the extension portion 66 therethrough when the inner boom section 40 is in the folded position and while the breakaway boom section 42 is in the extended position. For example, the first axis of rotation 54 may be a vertical axis of rotation oriented in the vertical direction V relative to the ground or the field surface. Moreover, the lock opening 80 may be defined through a structural member 70 of the breakaway boom section 42. However, it should be appreciated that, in alternative embodiments, the bracket plate 62 may be coupled to the breakaway boom section 42 and the lock opening 80 may be defined through the primary boom section 38.

Once the extension portion 66 of the bracket plate 62 has been received within the lock opening 80, the extension portion 66 is configured to engage the breakaway boom section 42 to limit or prevent unintended/undesired pivoting of the breakaway boom section 42 toward the folded position while the applicator 10 is transporting as opposed to performing spraying operations or other agricultural operations. Such unintended/undesired pivoting of the breakaway boom section 42 may occur while the applicator 10 is traversing a field. For example, the field may include rough terrain that jogs or loosens the breakaway hinge joint 68, thereby causing the breakaway section 42 to pivot toward the folded position. Unintended pivoting of the breakaway section 42 may cause the breakaway section 42 to collide with objects which damage the breakaway section 42 and/or the objects.

To limit or prevent unintended/undesired pivoting of the breakaway boom section 42 toward the folded position, the extension portion 66 of the bracket plate 62 may engage the breakaway boom section 62. In this respect, as shown in FIG. 7, the lock opening 80 may be bounded by an opening wall 82. The opening wall 82 may include an upper side 84, a lower side 86 opposite the upper side 84, and lateral opposing sides (not shown) that define a square or rectangular shape. Additionally, the second axis of rotation 56 about which the breakaway boom section 42 is pivotable may correspond to an oblique axis of rotation oriented in an oblique direction O relative to the ground or field surface. In this respect, the breakaway boom section 42 moves simultaneously upward in the vertical direction V while pivoting toward the folded position and downward in the vertical direction V while pivoting toward the extended position. As such, the opening wall 82, particularly the lower side 86, contacts the extension portion 66 and thus contains the extension portion 66 within the lock opening 80 when the breakaway boom section 42 moves simultaneously upward in the vertical direction V while pivoting toward the folded position. Thus, the pivoting of the breakaway boom section 42 toward the folded position is limited to the extent of the boundary of the lock opening 80.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural applicator, comprising:
a chassis; and
a boom assembly supported by the chassis, the boom assembly comprising:
a lift arm assembly; and
a boom arm supported by the lift arm assembly, the boom arm comprising:
a first boom section configured to pivot between a folded position and an extended position about a first pivot joint defining a first axis of rotation;
a second boom section coupled to the first boom section and configured to pivot between a folded position and an extended position about a second pivot joint relative to the first boom section, the second pivot joint defining a second axis of rotation different from the first axis of rotation;
a plurality of nozzles positioned along the first boom section and the second boom section for selectively applying an agricultural product to a field surface; and
a transport lock configured to be received within a bounded opening for limiting pivoting of the second boom section about the second pivot joint to an extent of the bounded opening when the first boom section is in the folded position.

2. The agricultural applicator of claim 1, wherein the first boom section corresponds to an inner boom section and the second boom section corresponds to a breakaway boom section, the boom assembly further comprising:
a primary boom section coupled to the lift arm assembly of the boom assembly; and
wherein:
the inner boom section is pivotably coupled to the primary boom section at the first pivot joint and configured to pivot between the folded position and the extended position relative to the primary boom section about the first pivot joint;
the breakaway boom section is pivotably coupled to the inner boom section at the second pivot joint; and
the transport lock is coupled to the primary boom section and configured to engage the breakaway boom section to limit pivoting of the breakaway boom section when the inner boom section is in the folded position.

3. The agricultural applicator of claim 2, wherein the transport lock is configured to engage the breakaway boom section to limit pivoting of the breakaway boom section toward the folded position when the inner boom section is in the folded position.

4. The agricultural applicator of claim 2, wherein:
the transport lock comprises a bracket plate protruding from the primary boom section; and
the breakaway boom section defines an opening corresponding to the bounded opening, the bounded opening configured to receive the bracket plate therethrough when the inner boom section is pivoted to the folded position and the breakaway boom section is in the extended position.

5. The agricultural applicator of claim 4, the bracket plate comprising:
a bracket portion configured to couple the bracket plate to the primary boom section; and
a finger portion protruding from the bracket portion and configured to be received through the bounded opening when the inner boom section is pivoted to the folded position and the breakaway boom section is in the extended position.

6. The agricultural applicator of claim 5, wherein:
the bounded opening of the breakaway boom section is bounded by an opening wall for limiting movement of the finger portion of the bracket plate within the wall; and
the finger portion of the bracket plate contacts the opening wall to limit pivoting of the breakaway boom section to the extent of the opening wall about the second pivot joint toward the folded position when the inner boom section is in the folded position.

7. The agricultural applicator of claim 1, wherein:
the first axis of rotation is oriented differently than the second axis of rotation.

8. The agricultural applicator of claim 1, wherein:
the first axis of rotation corresponds to a vertical axis of rotation; and
the second axis of rotation corresponds to an oblique axis of rotation.

9. A boom assembly for an agricultural applicator, comprising:
a lift arm assembly; and
a boom arm supported by the lift arm assembly, the boom arm comprising:
a primary boom section coupled to the lift arm assembly;
an inner boom section pivotably coupled to the primary boom section and configured to pivot between a folded position and an extended position relative to the primary boom section;
a breakaway boom section pivotably coupled to the inner boom section and configured to pivot between a folded position and extended position relative to the inner boom section;
a plurality of nozzles positioned along the primary boom section, the inner boom section, and the breakaway boom section for selectively applying an agricultural product to a field surface; and
a bracket plate coupled to the primary boom section and protruding therefrom, the bracket plate configured to engage the breakaway boom section to limit pivoting of the breakaway boom section when the inner boom section is in the folded position.

10. The boom assembly of claim 9, wherein:
the bracket plate is configured to engage the breakaway boom section to limit pivoting of the breakaway boom section toward the folded position when the inner boom section is in the folded position.

11. The boom assembly of claim 9, wherein:
the breakaway boom section defines an opening configured to receive the bracket plate therethrough when the inner boom section is pivoted to the folded position and the breakaway boom section is in the extended position.

12. The boom assembly of claim 11, wherein:
the opening of the breakaway boom section configured to receive the bracket plate is bounded by an opening wall; and
the bracket plate contacts the opening wall to limit pivoting of the breakaway boom section about the second pivot joint toward the folded position when the inner boom section is in the folded position.

13. The boom assembly of claim 9, wherein:
the inner boom section is pivotably coupled to the primary boom section at a first pivot joint defining a first axis of rotation and configured to pivot between the folded position and the extended position about the first pivot joint relative to the primary boom section; and
the breakaway boom section is pivotably coupled to the inner boom section at a second pivot joint and configured to pivot between the folded position and the extended position about the second pivot joint relative to the inner boom section, the second pivot joint defining a second axis of rotation different from the first axis of rotation.

14. The boom assembly of claim 13, wherein:
the bracket plate is configured to engage the breakaway boom section to limit pivoting of the breakaway boom section about the second pivot joint when the inner boom section is in the folded position.

15. The boom assembly of claim 13, wherein:
the first axis of rotation is oriented differently than the second axis of rotation.

16. An agricultural system, comprising:
a first boom section supported relative to a chassis of an agricultural applicator and configured to pivot between a folded position and an extended position about a first pivot joint, the first pivot joint defining a first axis of rotation;
a second boom section coupled to the first boom section and configured to pivot between a folded position and an extended position about a second pivot joint relative to the first boom section, the second pivot joint defining a second axis of rotation different from the first axis of rotation;
a plurality of nozzles positioned along the first boom section and the second boom section for selectively applying an agricultural product to a field surface; and
a transport lock configured to be received within a bounded opening for limiting pivoting of the second boom section about the second pivot joint to an extent of the bounded opening when the first boom section is in the folded position.

17. The agricultural system of claim 16, wherein the first boom section corresponds to an inner boom section and the second boom section corresponds to a breakaway boom section, the boom assembly further comprising:
a lift arm assembly; and
a primary boom section coupled to the lift arm assembly; and
wherein:
the inner boom section is pivotably coupled to the primary boom section at the first pivot joint and configured to pivot between the folded position and the extended position relative to the primary boom section about the first pivot joint;
the breakaway boom section is pivotably coupled to the inner boom section at the second pivot joint; and
the transport lock is coupled to the primary boom section and configured to engage the breakaway boom section to limit pivoting of the breakaway boom section when the inner boom section is in the folded position.

18. The agricultural system of claim 17, wherein the transport lock is configured to engage the breakaway boom section to limit pivoting of the breakaway boom section toward the folded position when the inner boom section is in the folded position.

19. The agricultural system of claim 17, wherein:
the transport lock comprises a bracket plate protruding from the primary boom section; and
the breakaway boom section defines an opening corresponding to the bounded opening, the bounded opening configured to receive the bracket plate therethrough when the inner boom section is pivoted to the folded position and the breakaway boom section is in the extended position.

20. The agricultural system of claim 19, wherein:
the bounded opening of the breakaway boom section is bounded by an opening wall for limiting movement of the bracket plate within the wall; and
the bracket plate contacts the opening wall to limit pivoting of the breakaway boom section to the extent of the opening wall about the second pivot joint toward the folded position when the inner boom section is in the folded position.
